(19) United States
(12) Patent Application Publication
(10) Pub. No.: US 2023/0254564 A1
(43) Pub. Date: Aug. 10, 2023

(54) PORTABLE ELECTRONIC DEVICE, AND IMAGE-CAPTURING DEVICE AND ASSEMBLY METHOD THEREOF

(71) Applicant: Shine Optics Technology Company Limited, Chongqing City (CN)

(72) Inventor: FENG ZHOU, Chongqing City (CN)

(21) Appl. No.: 18/079,982

(22) Filed: Dec. 13, 2022

(30) Foreign Application Priority Data
Dec. 21, 2021 (CN) 202123233152.0

(51) Int. Cl. H04N 5/228; G09G 5/00; G03B 17/12

(52) U.S. Cl. CPC H04N 23/57; H04N 23/55; G09G 5/003; H04N 23/54; G03B 17/12; H04N 23/20; H04N 23/13; H04N 23/50; G09G 2360/144

(57) ABSTRACT

A portable electronic device, and an image-capturing device and an assembling method thereof are provided. The image-capturing device includes a carrier substrate, a first image sensing chip, a first filter assembly and a first lens assembly. The first image sensing chip is disposed on the bottom side of the carrier substrate and electrically connected to the carrier substrate. The first filter assembly includes a first support element disposed on the carrier substrate and a first filter element configured for cooperating with the first support element. The first support element is configured to carry the first filter element such that all or a part of the first filter element can be received within the first through opening. The shortest distance between the first filter element and the first image sensing chip can range from 30 μm to 200 μm.

### CROSS-REFERENCE TO RELATED PATENT APPLICATION

This application claims the benefit of priority to China Patent Application No. 202123233152.0, filed on Dec. 21, 2021, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a portable electronic device, and an image-capturing device and an assembly method thereof, and more particularly to a portable electronic device for improving the quality of captured images, and an image-capturing device and an assembly method thereof for improving the quality of captured images.

### BACKGROUND OF THE DISCLOSURE

In the image-capturing device of the related art, the filter is supported by a plurality of short brackets to be arranged on the image sensor chip. However, the stability of a single short bracket and the flatness of the short brackets are not easy to control, and the short bracket that cannot be too high will make the filter and the image sensor chip too close, so that the microparticles on the filter will be captured by the image sensor chip (that is to say, the image sensor chip will capture the light spots caused by the blocking of microparticles).

### SUMMARY OF THE DISCLOSURE

In response to the above-referenced technical inadequacy, the present disclosure provides a portable electronic device, and an image-capturing device and an assembly method thereof, for improving the image-capturing quality.

In order to solve the above-mentioned problems, one of the technical aspects adopted by the present disclosure is to provide an image-capturing device, which includes a carrier substrate, a first image sensing chip, a second image sensing chip, a first filter assembly, a second filter assembly, a first lens assembly and a second lens assembly. The carrier substrate has a top side, a bottom side, a first through opening and a second through opening, and the first through opening and the second through opening are connected between the top side and the bottom side. The first image sensing chip is disposed on the bottom side of the carrier substrate and electrically connected to the carrier substrate. The second image sensing chip is disposed on the bottom side of the carrier substrate and electrically connected to the carrier substrate. The first filter assembly corresponds to the first image sensing chip, and the first filter assembly includes a first support element disposed on the carrier substrate and a first filter element cooperating with the first support element. The second filter assembly corresponds to the second image sensing chip, and the second filter assembly includes a second support element disposed on the carrier substrate and a second filter element cooperating with the second support element. The first lens assembly corresponds to the first image sensing chip, and the first lens assembly includes a first lens holder disposed on the top side of the carrier substrate and a first optical lens carried by the first lens holder. The second lens assembly corresponds to the second image sensing chip, and the second lens assembly includes a second lens holder disposed on the top side of the carrier substrate and a second optical lens carried by the second lens holder. The first image sensing chip, the first filter assembly and the first lens assembly cooperate with each other to form a first image sensing module for capturing invisible light. The second image sensing chip, the second filter assembly and the second lens assembly cooperate with each other to form a second image sensing module for capturing visible light. The first support element is configured to carry the first filter element, so that all or a part of the first filter element is accommodated in the first through opening. The second support element is configured to carry the second filter element, so that all or a part of the second filter element is accommodated in the second through opening. When at least one first microparticle with a maximum particle size between 5 μm and 25 μm is located on the first filter element, a shortest distance between the first filter element and the first image sensing chip is between 30 μm and 200 μm, so that the first image sensing chip cannot capture a light spot generated due to blocking of the at least one first microparticle. When at least one second microparticle with a maximum particle size between 5 μm and 25 μm is located on the second filter element, a shortest distance between the second filter element and the second image sensing chip is between 30 μm and 200 μm, so that the second image sensing chip cannot capture a light spot generated due to blocking of the at least one second microparticle.

In order to solve the above-mentioned problems, another one of the technical aspects adopted by the present disclosure is to provide a method of assembling an image-capturing device, which includes: placing at least one test microparticle with a maximum particle size between 5 μm and 25 μm on a test filter element; adjusting a shortest distance from the test filter element to a test image sensor chip until the test image sensor chip cannot capture a light spot generated due to blocking of the at least one test microparticle, in order to obtain a reference data of the shortest distance between the test filter element and the test image sensor chip ranging from 30 μm to 200 μm; and according to the reference data, placing a first image sensing chip, a second image sensing chip, a first filter assembly, a second filter assembly, a first lens assembly and a second lens assembly on a carrier substrate so as to define a shortest distance between the first filter element and the first image sensing chip ranging from 30 μm to 200 μm, and a shortest distance between the second filter element and the second image sensing chip ranging from 30 μm to 200 μm. The carrier substrate has a top side, a bottom side, a first through opening and a second through opening, and the first through opening and the second through opening are connected between the top side and the bottom side. The first image sensing chip and the second image sensing chip are disposed on the bottom side of the carrier substrate and electrically connected to the carrier substrate. The first filter assembly corresponds to the first image sensing chip, and the first filter assembly includes a first support element disposed on the carrier substrate and a first filter element cooperating with the first support element. The second filter assembly corresponds to the second image sensing chip, and the second filter assembly includes a second support element disposed on the carrier substrate and a second filter element cooperating with the second support element. The first lens assembly corresponds to the first image sensing chip, and the first lens assembly includes a first lens holder disposed on the top side of the carrier substrate and a first optical lens carried by the first lens holder. The second lens assembly corresponds to the second image sensing chip, and the second lens assembly includes a second lens holder disposed on the top side of the carrier substrate and a second optical lens carried by the second lens holder. The first image sensing chip, the first filter assembly and the first lens assembly cooperate with each other to form a first image sensing module for capturing invisible light. The second image sensing chip, the second filter assembly and the second lens assembly cooperate with each other to form a second image sensing module for capturing visible light. The first support element is configured to carry the first filter element, so that all or a part of the first filter element is accommodated in the first through opening. The second support element is configured to carry the second filter element, so that all or a part of the second filter element is accommodated in the second through opening.

In order to solve the above-mentioned problems, yet another one of the technical aspects adopted by the present disclosure is to provide a portable electronic device using an image-capturing device. The image-capturing device includes a carrier substrate, a first image sensing chip, a first filter assembly and a first lens assembly. The carrier substrate has a top side, a bottom side, a first through opening and a second through opening, and the first through opening and the second through opening are connected between the top side and the bottom side. The first image sensing chip is disposed on the bottom side of the carrier substrate and electrically connected to the carrier substrate. The first filter assembly corresponds to the first image sensing chip, and the first filter assembly includes a first support element disposed on the carrier substrate and a first filter element cooperating with the first support element. The first lens assembly corresponds to the first image sensing chip, and the first lens assembly includes a first lens holder disposed on the top side of the carrier substrate and a first optical lens carried by the first lens holder. The first image sensing chip, the first filter assembly and the first lens assembly cooperate with each other to form a first image sensing module for capturing invisible light. The first support element is configured to carry the first filter element, so that all or a part of the first filter element is accommodated in the first through opening. When at least one first microparticle with a maximum particle size between 5 μm and 25 μm is located on the first filter element, a shortest distance between the first filter element and the first image sensing chip is between 30 μm and 200 μm, so that the first image sensing chip cannot capture a light spot generated due to blocking of the at least one first microparticle.

Therefore, in the image-capturing device provided by the present disclosure, by virtue of “the first image sensing chip and the second image sensing chip being disposed on the bottom side of the carrier substrate and electrically connected to the carrier substrate,” “the first filter assembly including a first support element disposed on the carrier substrate and a first filter element cooperating with the first support element,” “the second filter assembly including a second support element disposed on the carrier substrate and a second filter element cooperating with the second support element,” “the first support element being configured to carry the first filter element so as to accommodate all or a part of the first filter element in the first through opening,” and “the second support element being configured to carry the second filter element so as to accommodate all or a part of the second filter element in the second through opening,” the image-capturing quality of the image-capturing device can be improved. More particularly, when at least one first microparticle with a maximum particle size between 5 μm and 25 μm is located on the first filter element, a shortest distance between the first filter element and the first image sensing chip is between 30 μm and 200 μm, so that the first image sensing chip cannot capture a light spot generated due to blocking of the at least one first microparticle. In addition, when at least one second microparticle with a maximum particle size between 5 μm and 25 μm is located on the second filter element, a shortest distance between the second filter element and the second image sensing chip is between 30 μm and 200 μm, so that the second image sensing chip cannot capture a light spot generated due to blocking of the at least one second microparticle.

Furthermore, in the image-capturing device provided by the present disclosure, by virtue of “placing at least one test microparticle with a maximum particle size between 5 μm and 25 μm on a test filter element,” “adjusting a shortest distance from the test filter element to a test image sensor chip until the test image sensor chip cannot capture a light spot generated due to blocking of the at least one test microparticle, in order to obtain a reference data of the shortest distance between the test filter element and the test image sensor chip ranging from 30 μm to 200 μm,” and “according to the reference data, placing a first image sensing chip, a second image sensing chip, a first filter assembly, a second filter assembly, a first lens assembly and a second lens assembly on a carrier substrate so as to define a shortest distance between the first filter element and the first image sensing chip ranging from 30 μm to 200 μm, and a shortest distance between the second filter element and the second image sensing chip ranging from 30 μm to 200 μm,” the image-capturing quality of the image-capturing device can be improved. More particularly, when at least one first microparticle with a maximum particle size between 5 μm and 25 μm is located on the first filter element, a shortest distance between the first filter element and the first image sensing chip is between 30 μm and 200 μm, so that the first image sensing chip cannot capture a light spot generated due to blocking of the at least one first microparticle. In addition, when at least one second microparticle with a maximum particle size between 5 μm and 25 μm is located on the second filter element, a shortest distance between the second filter element and the second image sensing chip is between 30 μm and 200 μm, so that the second image sensing chip cannot capture a light spot generated due to blocking of the at least one second microparticle.

Furthermore, in the portable electronic device using the image-capturing device provided by the present disclosure, by virtue of “the first image sensing chip and the second image sensing chip being disposed on the bottom side of the carrier substrate and electrically connected to the carrier substrate,” “the first filter assembly including a first support element disposed on the carrier substrate and a first filter element cooperating with the first support element,” and “the first support element being configured to carry the first filter element so as to accommodate all or a part of the first filter element in the first through opening,” the image-capturing quality of the image-capturing device can be improved. More particularly, when at least one first microparticle with a maximum particle size between 5 μm and 25 μm is located on the first filter element, a shortest distance between the first filter element and the first image sensing chip is between 30 μm and 200 μm, so that the first image sensing chip cannot capture a light spot generated due to blocking of the at least one first microparticle.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic top view of the image-capturing device provided by the first to third embodiments of the present disclosure;

FIG. 2 is a schematic front view of the image-capturing device provided by the first to third embodiments of the present disclosure;

FIG. 3 is a schematic perspective view of the image-capturing device provided by the first embodiment of the present disclosure;

FIG. 4 is a schematic perspective view of the portable electronic device provided by the first embodiment of the present disclosure;

FIG. 5 is a schematic view of the test microparticle, the test image sensing chip and the test filter element in the assembly method of the image-capturing device according to the first embodiment of the present disclosure;

FIG. 6 is a schematic view of a first implementation of the first image sensing module or the second image sensing module of the image-capturing device provided by the first embodiment of the present disclosure;

FIG. 7 is a schematic view of a second implementation of the first image sensing module or the second image sensing module of the image-capturing device provided by the first embodiment of the present disclosure;

FIG. 8 is a schematic view of a third implementation of the first image sensing module or the second image sensing module of the image-capturing device provided by the first embodiment of the present disclosure;

FIG. 9 is a schematic view of a first implementation of the first image sensing module or the second image sensing module of the image-capturing device provided by the second embodiment of the present disclosure;

FIG. 10 is a schematic view of a second implementation of the first image sensing module or the second image sensing module of the image-capturing device provided by the second embodiment of the present disclosure;

FIG. 11 is a schematic view of a third implementation of the first image sensing module or the second image sensing module of the image-capturing device provided by the second embodiment of the present disclosure;

FIG. 12 is a schematic view of a first implementation of the first image sensing module or the second image sensing module of the image-capturing device provided by the third embodiment of the present disclosure;

FIG. 13 is a schematic view of a second implementation of the first image sensing module or the second image sensing module of the image-capturing device provided by the third embodiment of the present disclosure; and

FIG. 14 is a schematic view of a third implementation of the first image sensing module or the second image sensing module of the image-capturing device provided by the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein.

Numbering terms such as “first,” “second” or “third” can be used to describe various components, signals or the like, which are for distinguishing one component/signal from another one only, and are not intended to, nor should be construed to impose any substantive limitations on the components, signals or the like.

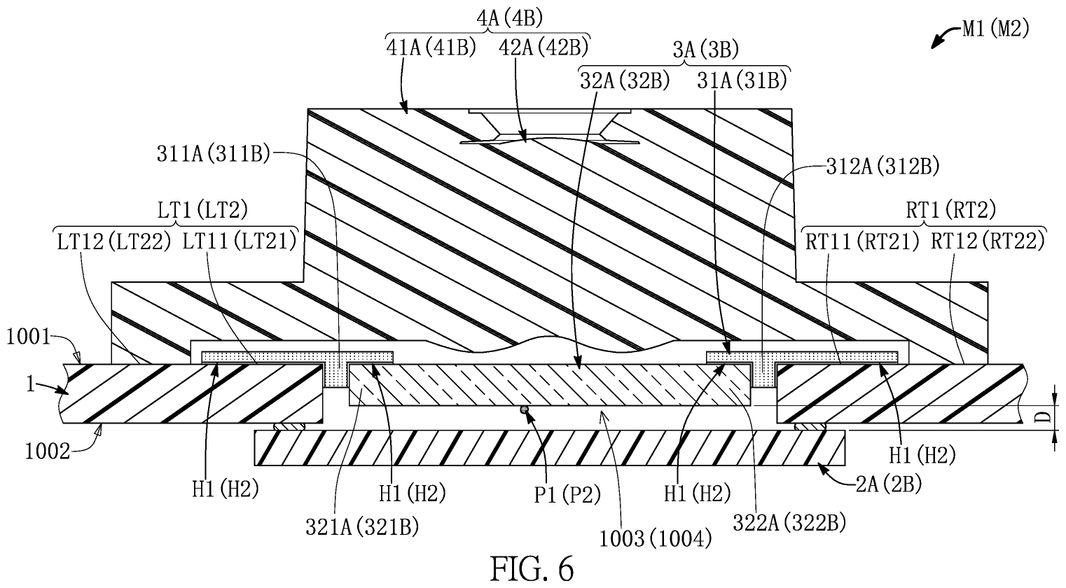

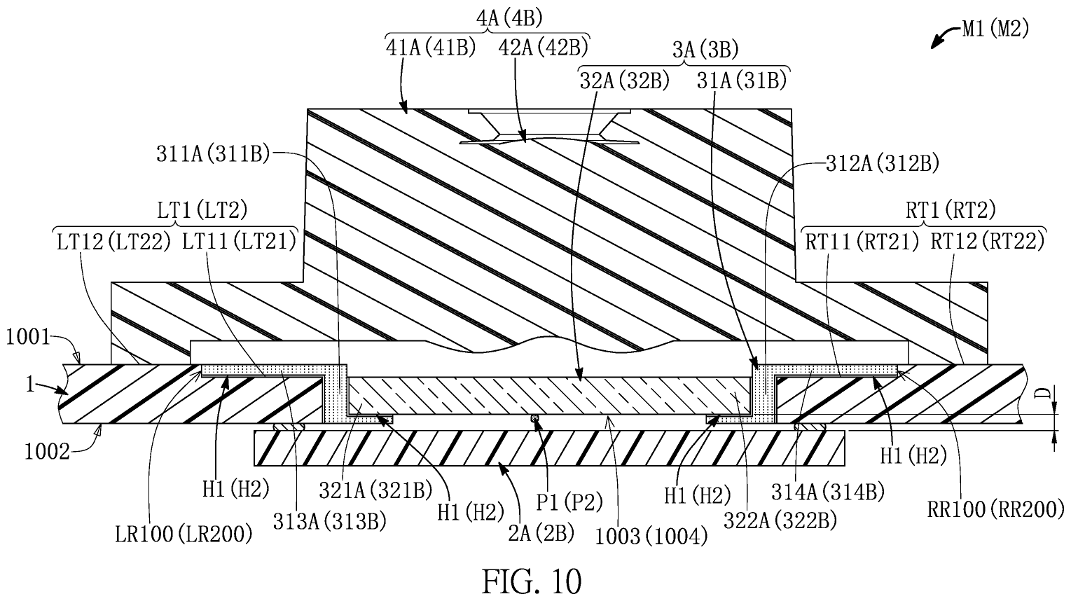

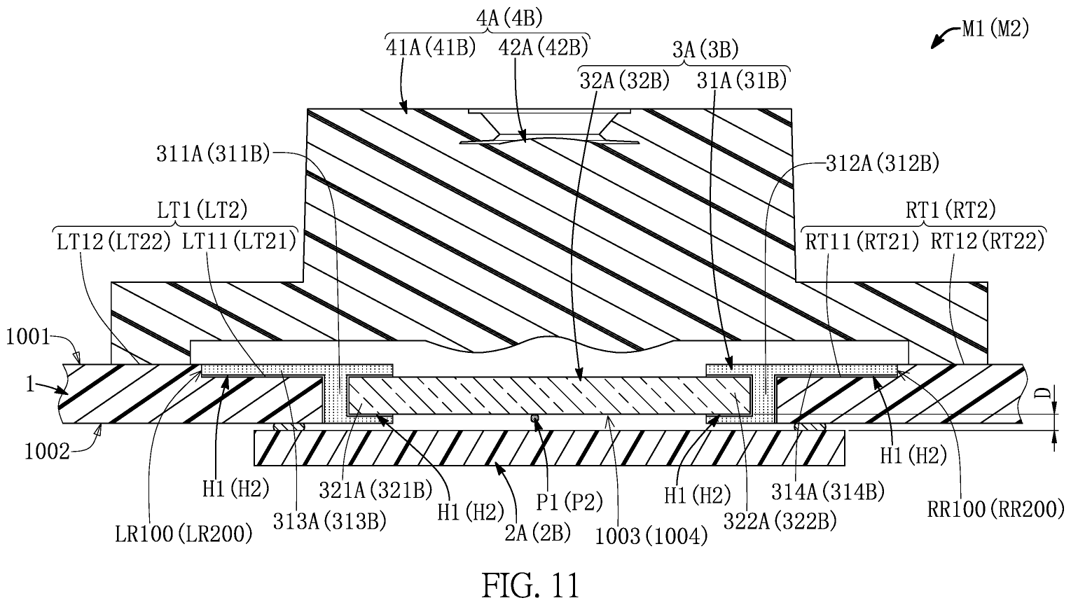

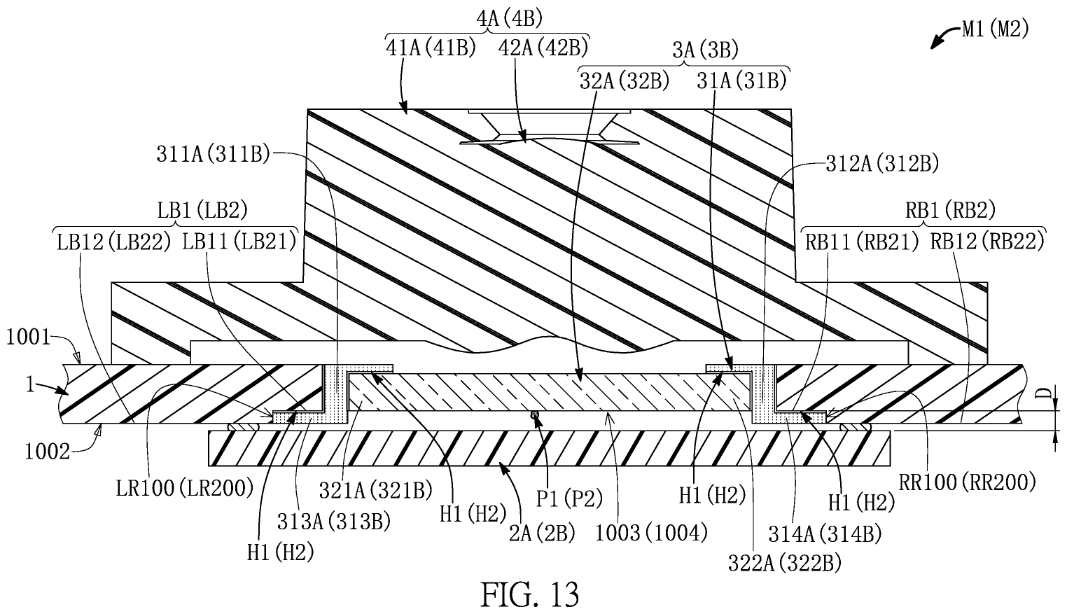

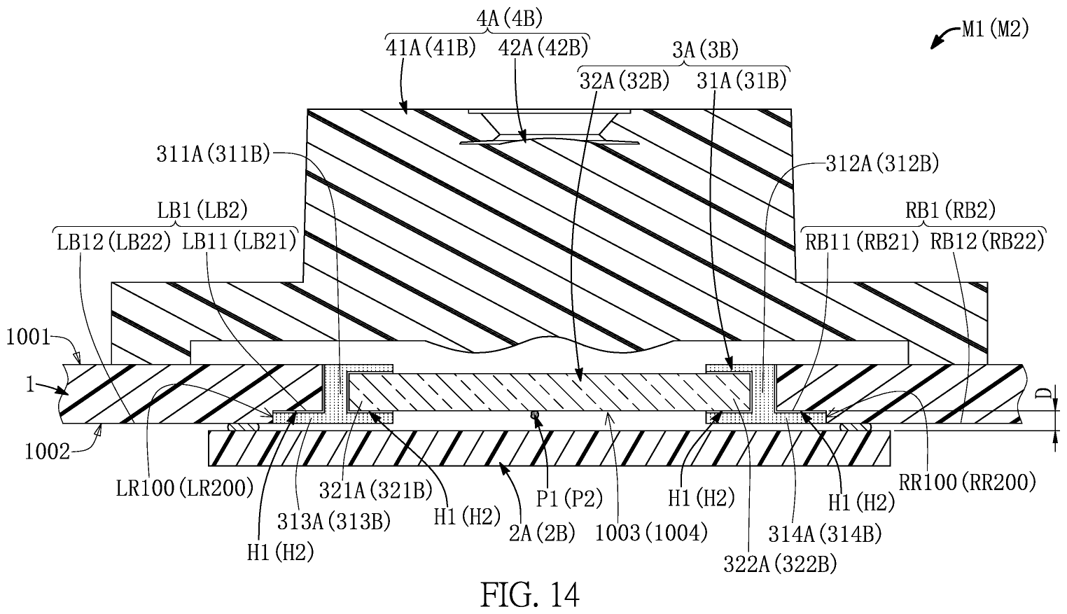

It should be noted that as shown in FIG. 6 to FIG. 14, the first image sensing module M1 and the second image sensing module M2 are disposed on different positions of the carrier substrate 1, and the first image sensing module M1 and the second image sensing module M2 can use the same or different sizes of optical elements. However, in order to simplify the description, the component symbols of both the first image sensing module M1 and the second image sensing module M2 are simultaneously shown in FIG. 6 to FIG. 14, in which the component symbols of the second image sensing module M2 are marked in brackets to facilitate the distinction.

### First Embodiment

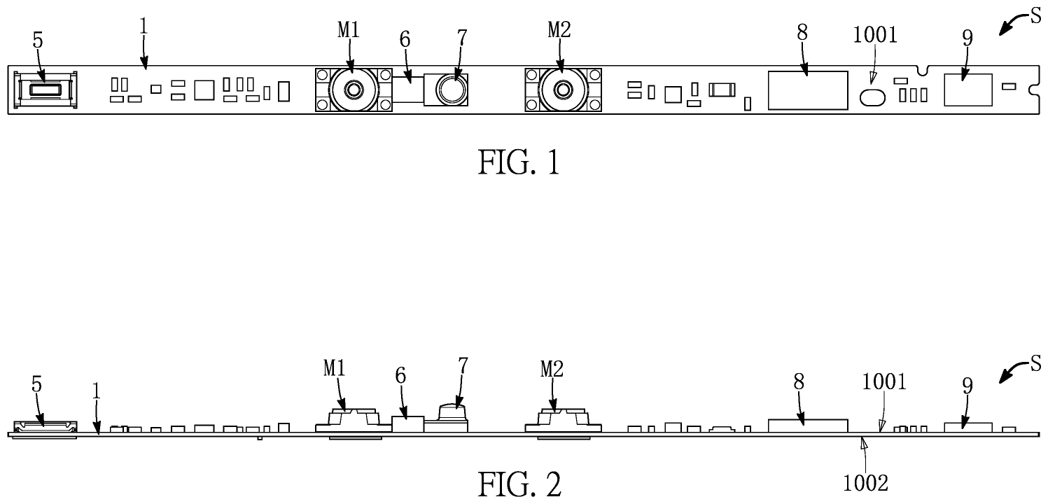

Referring to FIG. 1 to FIG. 8, a first embodiment of the present disclosure provides an image-capturing device S, which includes a carrier substrate 1, a first image sensing chip 2A, a second image sensing chip 2B, a first filter assembly 3A, a second filter assembly 3B, a first lens assembly 4A and a second lens assembly 4B.

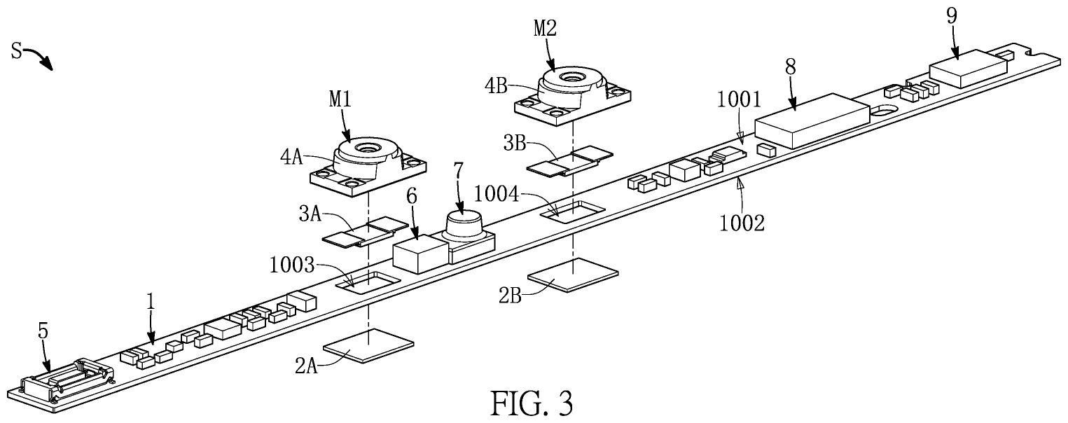

Firstly, referring to FIG. 2 and FIG. 3, the carrier substrate 1 has a top side 1001, a bottom side 1002, a first through opening 1003 (such as a first hollow hole) and a second through opening 1004 (such as a second hollow hole), and the first through opening 1003 and the second through opening 1004 are connected between the top side 1001 and the bottom side 1002. For example, the carrier substrate 1 can be an elongated circuit substrate or a circuit substrate of any shape.

Furthermore, referring to FIG. 2, FIG. 3 and FIG. 6, the first image sensing chip 2A and the second image sensing chip 2B are disposed on the bottom side 1002 of the carrier substrate 1 and electrically connected to the carrier substrate 1. For example, the first image sensing chip 2A can be an infrared photosensitive chip (using 720*640 resolution output), the first filter element 32A is an infrared filter, and the second image sensing chip 2B can be a visible light photosensitive chip (using 1980*1280 resolution output). In addition, the first image sensing chip 2A can be electrically connected to the carrier substrate 1 through a plurality of first conductive materials (such as solder balls, solder paste or any conductor as shown in FIG. 6, but not labeled), and the second image sensing chip 2B can be electrically connected to the carrier substrate 1 through a plurality of second conductive materials (such as solder balls, solder paste or any conductor as shown in FIG. 6, but not labeled).

Moreover, referring to FIG. 2, FIG. 3 and FIG. 6, the first filter assembly 3A corresponds to the first image sensing chip 2A on the optical path, and the first filter assembly 3A includes a first support element 31A disposed on the carrier substrate 1 and a first filter element 32A cooperating with the first support element 31A. In addition, the second filter assembly 3B corresponds to the second image sensing chip 2B on the optical path, and the second filter assembly 3B includes a second support element 31B disposed on the carrier substrate 1 and a second filter element 32B cooperating with the second support element 31B. For example, the first filter element 32A can be an infrared filter (having a wavelength about 850 nm), and the second filter element 32B can be a visible light filter. In addition, a minimum thickness (such as a thickness between 0.05 mm and 0.08 mm) of the first support element 31A is smaller than a thickness (such as a thickness between 1 mm and 1.5 mm) of the first filter element 32A, and a minimum thickness (such as a thickness between 0.05 mm and 0.08 mm) of the second support element 31B is smaller than a thickness (such as a thickness between 1 mm and 1.5 mm) of the second filter element 32B.

More particularly, referring to FIG. 2, FIG. 3 and FIG. 6, the first support element 31A is only connected to the carrier substrate 1 and is not in contact with the first image sensing chip 2A, and the second support element 31B is only connected to the carrier substrate 1 and is not in contact with the second image sensing chip 2B. In addition, the first support element 31A is connected between the carrier substrate 1 and the first filter element 32A through a plurality of first adhesive layers H1, and the second support element 31B is connected between the carrier substrate 1 and the second filter element 32B through a plurality of second adhesive layers H2. For example, since the adhesive force of the first adhesive layer H1 used between the first support element 31A and the carrier substrate 1 can be greater than the adhesive force of the first adhesive layer H1 used between the first filter element 32A and the carrier substrate 1, the first filter assembly 3A can be more firmly adhered to the carrier substrate 1 through the use of the first support element 31A. In addition, since the adhesive force of the second adhesive layer H2 used between the second support element 31B and the carrier substrate 1 can be greater than the adhesive force of the second adhesive layer H2 used between the second filter element 32B and the carrier substrate 1, the second filter assembly 3B can be more firmly adhered to the carrier substrate 1 through the use of the second support element 31B.

Moreover, referring to FIG. 2, FIG. 3 and FIG. 6, the first lens assembly 4A corresponds to the first image sensing chip 2A on the optical path, and the first lens assembly 4A includes a first lens holder 41A disposed on the top side 1001 of the carrier substrate 1 and a first optical lens 42A that is carried by the first lens holder 41A. In addition, the second lens assembly 4B corresponds to the second image sensing chip 2B on the optical path, and the second lens assembly 4B includes a second lens holder 41B disposed on the top side 1001 of the carrier substrate 1 and a second optical lens 42B that is carried by the second lens holder 41B. For example, the first optical lens 42A can be an infrared lens (having a wavelength about 850 nm), and the second optical lens 42B can be a visible light lens. In addition, the first lens holder 41A downwardly contacts or abuts against the first support element 31A (not shown in figures), or the first lens holder 41A is separate from the first support element 31A (as shown in FIG. 6), and the second lens holder 41B downwardly contacts or abuts against the second support element 31B (not shown in figures), or the second lens holder 41B is separate from the second support element 31B (as shown in FIG. 6). It should be noted that the first image sensing chip 2A, the first filter assembly 3A and the first lens assembly 4A can cooperate with each other to form a first image sensing module M1 for capturing invisible light (for example, it can be used to realize functions such as face recognition unlocking and anti-peeping etc.), and the second image sensing chip 2B, the second filter assembly 3B and the second lens assembly 4B can cooperate with each other to form a second image sensing module M2 for capturing visible light (for example, it can be used to realize image or video capture function).

More particularly, referring to FIG. 3 and FIG. 6, the first support element 31A can be configured to carry the first filter element 32A, so that all (i.e., 100% as shown in FIG. 6) or a part (such as any positive integer percentage between 30% and 99%) of the first filter element 32A is accommodated in the first through opening 1003. In this way, the overlapping percentage (i.e., the overlapping ratio) of the first filter element 32A and the carrier substrate 1 in the thickness direction can be increased, thereby effectively reducing the overall thickness of the first image sensing module M1 (for example, the overall thickness of the first image sensing module M1 is not greater than 1.8 mm). In addition, the second support element 31B can be configured to carry the second filter element 32B, so that all (i.e., 100% as shown in FIG. 6) or a part (such as any positive integer percentage between 30% and 99%) of the second filter element 32B is accommodated in the second through opening 1004. In this way, the overlapping percentage (i.e., the overlapping ratio) of the second filter element 32B and the carrier substrate 1 in the thickness direction can be increased, thereby effectively reducing the overall thickness of the second image sensing module M2 (for example, the overall thickness of the second image sensing module M2 is not greater than 1.8 mm). It should be noted that an overall thickness of the second image sensing module M2 can be greater than, smaller than, or the same as an overall thickness of the first image sensing module M1. In addition, the carrier substrate 1 can also form a first recessed area (not shown) and a second recessed area (not shown) on the bottom side 1002, and the first image sensing chip 2A and the second image sensing chip 2B can be completely or partially accommodated in the first recessed area and the second recessed area of the carrier substrate 1, thereby increasing the overlapping percentage of the first image sensing chip 2A and the carrier substrate 1 in the thickness direction (i.e., reducing the overall thickness of the first image sensing module M1), and increasing the overlapping percentage of the second image sensing chip 2B and the carrier substrate 1 in the thickness direction (i.e., reducing the overall thickness of the second image sensing module M2).

Therefore, when at least one first microparticle P1 with a maximum particle size between 5 μm and 25 μm (for example, according to different environmental considerations, it can be any positive integer between 5 μm and 25 μm, or an interval defined by any two positive integers between 5 μm and 25 μm, such as between 5 μm and 15 μm, or between 15 μm and 25 μm) is located on the first filter element 32A (for example, on the upper or lower surface of the first filter element 32A), a shortest distance D between the first filter element 32A and the first image sensing chip 2A is between 30 μm and 200 μm (for example, according to different application product considerations, it can be any positive integer between 30 μm and 200 μm, or an interval defined by any two positive integers between 30 μm and 200 μm, such as between 30 μm and 80 μm, or between 80 μm and 130 μm, or between 130 μm and 200 μm), so that the first image sensing chip 2A cannot capture a light spot (or an image spot) generated due to blocking (or shielding) of the at least one first microparticle P1. That is to say, the at least one first microparticle P1 with a maximum particle size between 5 μm and 25 μm can be separated from the first image sensing chip 2A by a sufficient distance due to the setting of the shortest distance D, so that the first image sensing chip 2A will not capture the image of the at least one first microparticle P1, and the at least one first microparticle P1 will not be imaged on the first image sensing chip 2A, thereby improving the image-capturing quality of the first image sensing chip 2A. In addition, when at least one second microparticle P2 with a maximum particle size between 5 μm and 25 μm (for example, according to different environmental considerations, it can be any positive integer between 5 μm and 25 μm, or an interval defined by any two positive integers between 5 μm and 25 μm, such as between 5 μm and 15 μm, or between 15 μm and 25 μm) is located on the second filter element 32B (for example, on the upper or lower surface of the second filter element 32A), a shortest distance D between the second filter element 32B and the second image sensing chip 2B is between 30 μm and 200 μm (for example, according to different application product considerations, it can be any positive integer between 30 μm and 200 μm, or an interval defined by any two positive integers between 30 μm and 200 μm, such as between 30 μm and 80 μm, or between 80 μm and 130 μm, or between 130 μm and 200 μm), so that the second image sensing chip 2B cannot capture a light spot (or an image spot) generated due to blocking (or shielding) of the at least one second microparticle P2. That is to say, the at least one second microparticle P2 with a maximum particle size between 5 μm and 25 μm can be separated from the second image sensing chip 2B by a sufficient distance due to the setting of the shortest distance D, so that the second image sensing chip 2B will not capture the image of the at least one second microparticle P2, and the at least one second microparticle P2 will not be imaged on the second image sensing chip 2B, thereby improving the image-capturing quality of the second image sensing chip 2B.

For example, referring to FIG. 1 to FIG. 3, the image-capturing device S provided by the first embodiment of the present disclosure further includes an electrical connector 5, an ambient light sensor 6 (such as an infrared light sensing chip with a wavelength of about 850 nm), an infrared generator 7 (such as an infrared LED lamp with a wavelength of about 850 nm), an image processor 8 (such as an ISP chip) and a sound receiver 9 (such as a microphone), and the electrical connector 5, the ambient light sensor 6, the infrared generator 7, the image processor 8 and the sound receiver 9 are disposed on the top side 1001 of the carrier substrate 1 and electrically connected to the carrier substrate 1. More particularly, the electrical connector 5, the first image sensing module M1, the ambient light sensor 6, the infrared generator 7, the second image sensing module M2, the image processor 8 and the sound receiver 9 can be sequentially disposed on the carrier substrate 1, so that the present disclosure can provide an image-capturing device S with high density arrangement and small overall thickness, and can support the Window Hello function supported by the Windows 11 system released by Microsoft. It is worth mentioning that the ambient light sensor 6 and the infrared generator 7 can be closer to the first image sensing module M1 than the second image sensing module M2, and the first image sensing module M1 and the second image sensing module M2 are arranged on the same carrier substrate 1 to form a dual camera module.

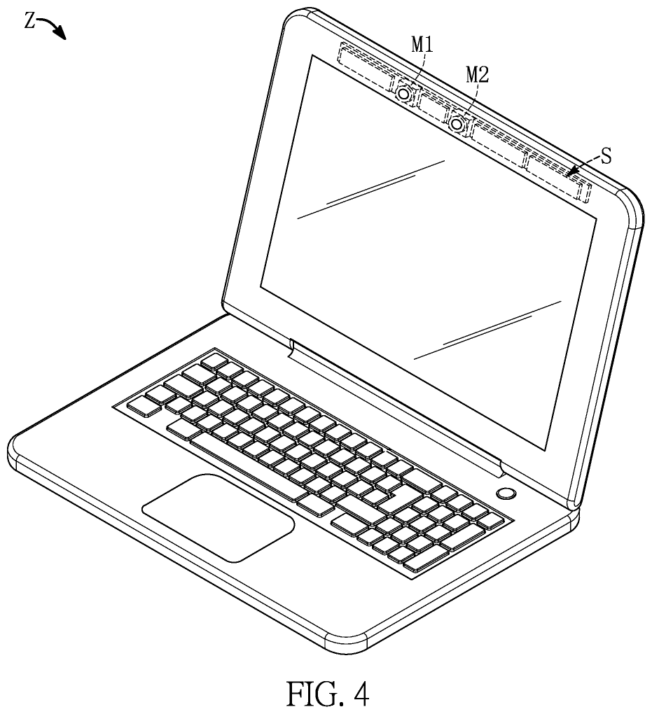

More particularly, referring to FIG. 3 and FIG. 4, the first embodiment of the present disclosure further includes a portable electronic device Z using an image-capturing device S at least including the first image sensing module M1 and the second image sensing module M2. For example, the portable electronic device Z can be a notebook computer, a tablet computer or a smart mobile phone. However, the aforementioned details are disclosed for exemplary purposes only, and are not meant to limit the scope of the present disclosure.

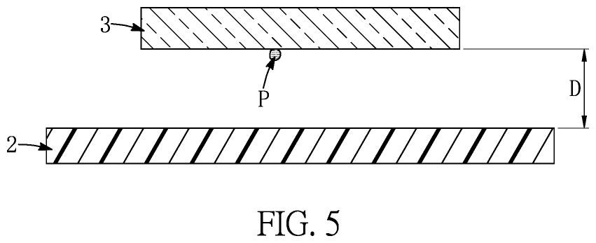

More particularly, referring to FIG. 3, FIG. 5 and FIG. 6, the first embodiment of the present disclosure further includes a method of assembling an image-capturing device S, which includes: firstly, as shown in FIG. 5, placing at least one test microparticle P (such as a physical or virtual microparticle) with a maximum particle size between 5 μm and 25 μm on a test filter element 3 (such as a physical or virtual filter element); next, as shown in FIG. 5, adjusting a shortest distance D from the test filter element 3 to a test image sensor chip 2 until the test image sensor chip 2 cannot capture a light spot (or an image spot) generated due to blocking of the at least one test microparticle P, in order to obtain a reference data of the shortest distance D between the test filter element 3 and the test image sensor chip 2 ranging from 30 μm to 200 μm; and then as shown in FIG. 6, according to the reference data, placing a first image sensing chip 2A, a second image sensing chip 2B, a first filter assembly 3A, a second filter assembly 3B, a first lens assembly 4A and a second lens assembly 4B on a carrier substrate 1 so as to define a shortest distance D between the first filter element 32A and the first image sensing chip 2A ranging from 30 μm to 200 μm, and a shortest distance D between the second filter element 32B and the second image sensing chip 2B ranging from 30 μm to 200 μm. For example, the method of assembling the image-capturing device S provided by the first embodiment of the present disclosure further includes: placing an electrical connector 5, an ambient light sensor 6, an infrared generator 7, an image processor 8 and a sound receiver 9 on the top side 1001 of the carrier substrate 1 to electrically connect to the carrier substrate 1.

For example, referring to FIG. 3 and FIG. 6, the following content is described with the first implementation of the first image sensing module M1. The top side 1001 of the carrier substrate 1 has a first left top carrier surface LT1 and a first right top carrier surface RT1, the first left top carrier surface LT1 has a first inner surface LT11 and a first outer surface LT12 that are flush with each other, and the first right top carrier surface RT1 has a first inner surface RT11 and a first outer surface RT12 that are flush with each other. More particularly, the first inner surface LT11 of the first left top carrier surface LT1 and the first inner surface RT11 of the first right top carrier surface RT1 can be configured to carry the first support element 31A (for example, the first support element 31A may be a single member, or a left and a right member separate from each other), and the first outer surface LT12 of the first left top carrier surface LT1 and the first outer surface RT12 of the first right top carrier surface RT1 can be configured to carry the first lens holder 41A. It should be noted that the first filter element 32A has a first left portion 321A and a first right portion 322A corresponding to the first left portion 321A, an upper surface of the first left portion 321A of the first filter element 32A and all or a part of a lateral surface of the first left portion 321A of the first filter element 32A are covered by a first left inner portion 311A of the first support element 31A, and an upper surface of the first right portion 322A of the first filter element 32A and all or a part of a lateral surface of the first right portion 322A of the first filter element 32A are covered by a first right inner portion 312A of the first support element 31A.

For example, referring to FIG. 3 and FIG. 6, the following content is described with the first implementation of the second image sensing module M2. The top side 1001 of the carrier substrate 1 has a second left top carrier surface LT2 and a second right top carrier surface RT2, the second left top carrier surface LT2 has a second inner surface LT21 and a second outer surface LT22 that are flush with each other, and the second right top carrier surface RT2 has a second inner surface RT21 and a second outer surface RT22 that are flush with each other. More particularly, the second inner surface LT21 of the second left top carrier surface LT2 and the second inner surface RT21 of the second right top carrier surface RT2 can be configured to carry the second support element 31B (for example, the second support element 31B may be a single member, or a left and a right member separate from each other), and the second outer surface LT22 of the second left top carrier surface LT2 and the second outer surface RT22 of the second right top carrier surface RT2 can be configured to carry the second lens holder 41B. It should be noted that the second filter element 32B has a second left portion 321B and a second right portion 322B corresponding to the second left portion 321B, an upper surface of the second left portion 321B of the second filter element 32B and all or a part of a lateral surface of the second left portion 321B of the second filter element 32B are covered by a second left inner portion 311B of the second support element 31B, and an upper surface of the second right portion 322B of the second filter element 32B and all or a part of a lateral surface of the second right portion 322B of the second filter element 32B are covered by a second right inner portion 312B of the second support element 31B.

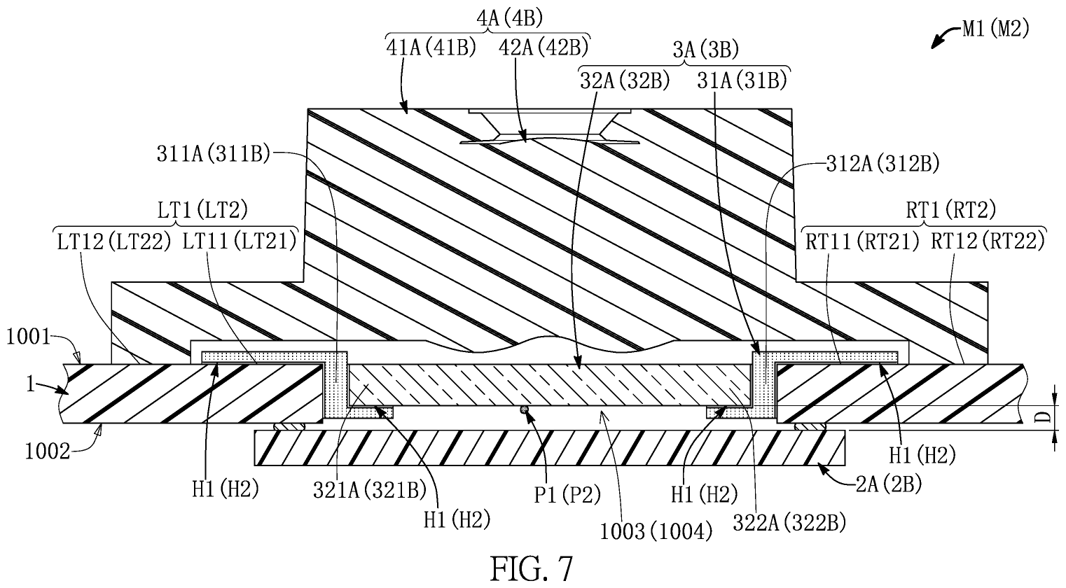

For example, referring to FIG. 3 and FIG. 7, the following content is described with the second implementation of the first image sensing module M1. A lower surface of the first left portion 321A of the first filter element 32A and all or a part of a lateral surface of the first left portion 321A of the first filter element 32A are covered by a first left inner portion 311A of the first support element 31A, and a lower surface of the first right portion 322A of the first filter element 32A and all or a part of a lateral surface of the first right portion 322A of the first filter element 32A are covered by a first right inner portion 312A of the first support element 31A. In addition, the following content is described with the second implementation of the second image sensing module M2. A lower surface of the second left portion 321B of the second filter element 32B and all or a part of a lateral surface of the second left portion 321B of the second filter element 32B are covered by a second left inner portion 311B of the second support element 31B, and a lower surface of the second right portion 322B of the second filter element 32B and all or a part of a lateral surface of the second right portion 322B of the second filter element 32B are covered by a second right inner portion 312B of the second support element 31B. Thereby, the structural stability and structural strength of the first filter assembly 3A and the second filter assembly 3B can be effectively improved, so that the first filter element 32A does not easily detach from the first support element 31A, and the second filter element 32B does not easily detach from second support element 31B.

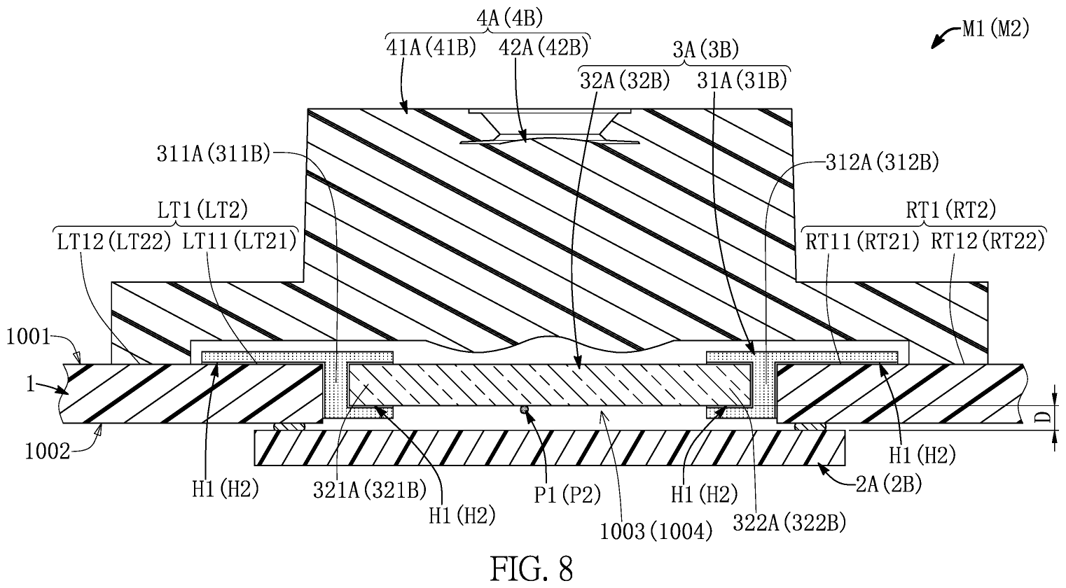

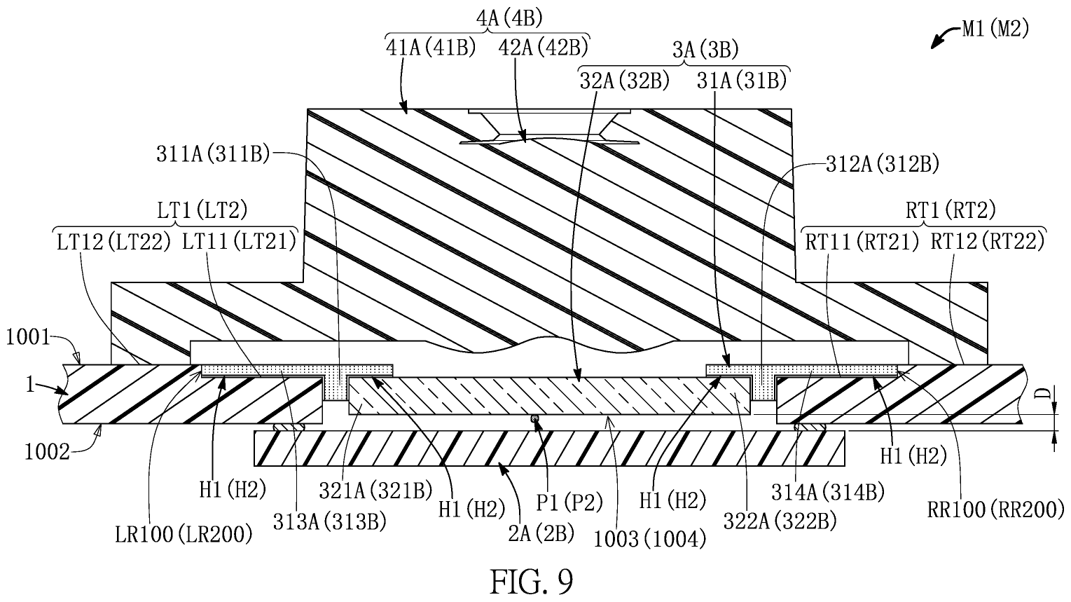

For example, referring to FIG. 3 and FIG. 8, the following content is described with the third implementation of the first image sensing module M1. An upper surface, a lower surface and a lateral surface of the first left portion 321A of the first filter element 32A are covered by a first left inner portion 311A of the first support element 31A, an upper surface, a lower surface and a lateral surface of the first right portion 322A of the first filter element 32A are covered by a first right inner portion 312A of the first support element 31A. In addition, the following content is described with the third implementation of the second image sensing module M2. An upper surface, a lower surface and a lateral surface of the second left portion 321B of the second filter element 32B are covered by a second left inner portion 311B of the second support element 31B, and an upper surface, a lower surface and a lateral surface of the second right portion 322B of the second filter element 32B are covered by a second right inner portion 312B of the second support element 31B. Thereby, the structural stability and structural strength of the first filter assembly 3A and the second filter assembly 3B can be effectively improved, so that the first filter element 32A does not easily detach from the first support element 31A, and the second filter element 32B does not easily detach from second support element 31B.

### Second Embodiment

Referring to FIG. 1, FIG. 2 and FIG. 9 to FIG. 11, a second embodiment of the present disclosure provides an image-capturing device S. From the comparison of FIG. 9 to FIG. 11 with FIG. 6 to FIG. 8 respectively, the main difference between the second embodiment and the first embodiment is as follows.

Referring to FIG. 9 to FIG. 11, in the second embodiment, the following content is described with the first, second and third implementations of the first image sensing module M1. The top side 1001 of the carrier substrate 1 has a first left top carrier surface LT1 and a first right top carrier surface RT1, the first left top carrier surface LT1 has a first inner surface LT11 and a first outer surface LT12 that both have a height difference, and the first right top carrier surface RT1 has a first inner surface RT11 and a first outer surface RT12 that both have a height difference. More particularly, the first inner surface LT11 and the first outer surface LT12 of the first left top carrier surface LT1 have a height difference, and the first inner surface RT11 and the first outer surface RT12 of the first right top carrier surface RT1 have a height difference, so that the carrier substrate 1 can provide a first left recessed space LR100 and a first right recessed space RR100 for respectively accommodating a first left outer portion 313A and a first right outer portion 314A of the first support element 31A, thereby reducing the shortest distance D between the first filter element 32A and the first image sensing chip 2A (that is to say, the shortest distance D shown in FIG. 9 to FIG. 11 can be smaller than the shortest distance D shown in FIG. 6 to FIG. 8). It should be noted that, according to different requirements, both the first left recessed space LR100 and the first right recessed space RR100 can be separate from each other without communicating with each other, or connected and communicated with each other.

Referring to FIG. 9 to FIG. 11, in the second embodiment, the following content is described with the first, second and third implementations of the second image sensing module M2. The top side 1001 of the carrier substrate 1 has a second left top carrier surface LT2 and a second right top carrier surface RT2, the second left top carrier surface LT2 has a second inner surface LT21 and a second outer surface LT22 that both have a height difference, and the second right top carrier surface RT2 has a second inner surface RT21 and a second outer surface RT22 that both have a height difference. More particularly, the second inner surface LT21 and the second outer surface LT22 of the second left top carrier surface LT2 have a height difference, and the second inner surface RT21 and the second outer surface RT22 of the second right top carrier surface RT2 have a height difference, so that the carrier substrate 1 can provide a second left recessed space LR200 and a second right recessed space RR200 for respectively accommodating a second left outer portion 313B and a second right outer portion 314B of the second support element 31B, thereby reducing the shortest distance D between the second filter element 32B and the second image sensing chip 2B (that is to say, the shortest distance D shown in FIG. 9 to FIG. 11 can be smaller than the shortest distance D shown in FIG. 6 to FIG. 8). It should be noted that, according to different requirements, both the second left recessed space LR200 and the second right recessed space RR200 can be separate from each other without communicating with each other, or connected and communicated with each other.

### Third Embodiment

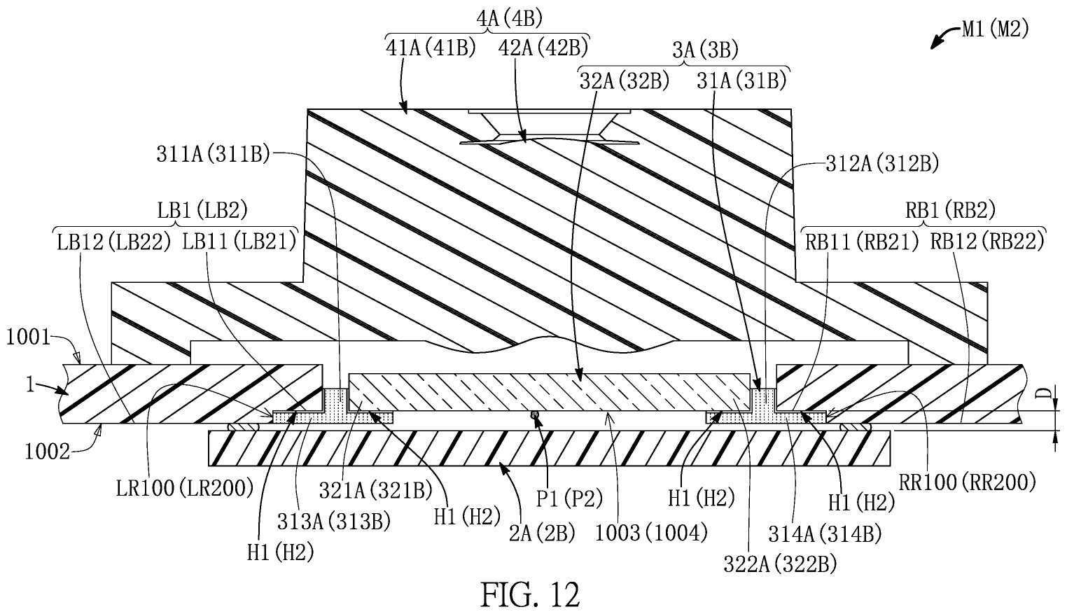

Referring to FIG. 1, FIG. 2 and FIG. 12 to FIG. 14, a third embodiment of the present disclosure provides an image-capturing device S. From the comparison of FIG. 12 to FIG. 14 with FIG. 6 to FIG. 8 respectively, the main difference between the third embodiment and the first embodiment is as follows.

Referring to FIG. 12 to FIG. 14, in the third embodiment, the following content is described with the first, second and third implementations of the first image sensing module M1. The bottom side 1002 of the carrier substrate 1 has a first left bottom carrier surface LB1 and a first right bottom carrier surface RB1, the first left bottom carrier surface LB1 has a first inner surface LB11 and a first outer surface LB12 that both have a height difference, and the first right bottom carrier surface RB1 has a first inner surface RB11 and a first outer surface RB12 that both have a height difference. In addition, the first inner surface LB11 of the first left bottom carrier surface LB1 and the first inner surface RB11 of the first right bottom carrier surface RB1 can be configured to carry the first support element 31A, and the first outer surface LB12 of the first left bottom carrier surface LB1 and the first outer surface RB12 of the first right bottom carrier surface RB1 can be configured to carry the first image sensing chip 2A. More particularly, the first inner surface LB11 and the first outer surface LB12 of the first left bottom carrier surface LB1 have a height difference, and the first inner surface RB11 and the first outer surface RB12 of the first right bottom carrier surface RB1 have a height difference, so that the carrier substrate 1 can provide a first left recessed space LR100 and a first right recessed space RR100 for respectively accommodating a first left outer portion 313A and a first right outer portion 314A of the first support element 31A, thereby reducing the shortest distance D between the first filter element 32A and the first image sensing chip 2A (that is to say, the shortest distance D shown in FIG. 12 to FIG. 14 can be smaller than the shortest distance D shown in FIG. 6 to FIG. 8). It should be noted that, according to different requirements, both the first left recessed space LR100 and the first right recessed space RR100 can be separate from each other without communicating with each other, or connected and communicated with each other.

Referring to FIG. 12 to FIG. 14, in the third embodiment, the following content is described with the first, second and third implementations of the second image sensing module M2. The bottom side 1002 of the carrier substrate 1 has a second left bottom carrier surface LB2 and a second right bottom carrier surface RB2, the second left bottom carrier surface LB2 has a second inner surface LB21 and a second outer surface LB22 that both have a height difference, and the second right bottom carrier surface RB2 has a second inner surface RB21 and a second outer surface RB22 that both have a height difference. In addition, the second inner surface LB21 of the second left bottom carrier surface LB2 and the second inner surface RB21 of the second right bottom carrier surface RB2 can be configured to carry the second support element 31B, and the second outer surface LB22 of the second left bottom carrier surface LB2 and the second outer surface RB22 of the second right bottom carrier surface RB2 can be configured to carry the second image sensing chip 2B. More particularly, the second inner surface LB21 and the second outer surface LB22 of the second left bottom carrier surface LB2 have a height difference, and the second inner surface RB21 and the second outer surface RB22 of the second right bottom carrier surface RB2 have a height difference, so that the carrier substrate 1 can provide a second left recessed space LR200 and a second right recessed space RR200 for respectively accommodating a second left outer portion 313B and a second right outer portion 314B of the second support element 31B, thereby reducing the shortest distance D between the second filter element 32B and the second image sensing chip 2B (that is to say, the shortest distance D shown in FIG. 12 to FIG. 14 can be smaller than the shortest distance D shown in FIG. 6 to FIG. 8). It should be noted that, according to different requirements, both the second left recessed space LR200 and the second right recessed space RR200 can be separate from each other without communicating with each other, or connected and communicated with each other.

### Beneficial Effects of the Embodiments

In conclusion, in the image-capturing device S provided by the present disclosure, by virtue of “the first image sensing chip 2A and the second image sensing chip 2B being disposed on the bottom side 1002 of the carrier substrate 1 and electrically connected to the carrier substrate 1,” “the first filter assembly 3A including a first support element 31A disposed on the carrier substrate 1 and a first filter element 32A cooperating with the first support element 31A,” “the second filter assembly 3B including a second support element 31B disposed on the carrier substrate 1 and a second filter element 32B cooperating with the second support element 31B,” “the first support element 31A being configured to carry the first filter element 32A so as to accommodate all or a part of the first filter element 32A in the first through opening 1003,” and “the second support element 31B being configured to carry the second filter element 32B so as to accommodate all or a part of the second filter element 32B in the second through opening 1004,” the image-capturing quality of the image-capturing device S can be improved. More particularly, when at least one first microparticle P1 with a maximum particle size between 5 μm and 25 μm is located on the first filter element 32A, a shortest distance D between the first filter element 32A and the first image sensing chip 2A is between 30 μm and 200 μm, so that the first image sensing chip 2A cannot capture a light spot generated due to blocking of the at least one first microparticle P1. In addition, when at least one second microparticle P2 with a maximum particle size between 5 μm and 25 μm is located on the second filter element 32B, a shortest distance D between the second filter element 32B and the second image sensing chip 2B is between 30 μm and 200 μm, so that the second image sensing chip 2B cannot capture a light spot generated due to blocking of the at least one second microparticle P2.

Furthermore, in the image-capturing device S provided by the present disclosure, by virtue of “placing at least one test microparticle with a maximum particle size between 5 μm and 25 μm on a test filter element,” “adjusting a shortest distance D from the test filter element to a test image sensor chip until the test image sensor chip cannot capture a light spot generated due to blocking of the at least one test microparticle, in order to obtain a reference data of the shortest distance D between the test filter element and the test image sensor chip ranging from 30 μm to 200 μm,” and “according to the reference data, placing a first image sensing chip 2A, a second image sensing chip 2B, a first filter assembly 3A, a second filter assembly 3B, a first lens assembly 4A and a second lens assembly 4B on a carrier substrate 1 so as to define a shortest distance D between the first filter element 32A and the first image sensing chip 2A ranging from 30 μm to 200 μm, and a shortest distance D between the second filter element 32B and the second image sensing chip 2B ranging from 30 μm to 200 μm,” the image-capturing quality of the image-capturing device S can be improved. More particularly, when at least one first microparticle P1 with a maximum particle size between 5 μm and 25 μm is located on the first filter element 32A, a shortest distance D between the first filter element 32A and the first image sensing chip 2A is between 30 μm and 200 μm, so that the first image sensing chip 2A cannot capture a light spot generated due to blocking of the at least one first microparticle P1. In addition, when at least one second microparticle P2 with a maximum particle size between 5 μm and 25 μm is located on the second filter element 32B, a shortest distance D between the second filter element 32B and the second image sensing chip 2B is between 30 μm and 200 μm, so that the second image sensing chip 2B cannot capture a light spot generated due to blocking of the at least one second microparticle P2.

Furthermore, in the portable electronic device using the image-capturing device S provided by the present disclosure, by virtue of “the first image sensing chip 2A and the second image sensing chip 2B being disposed on the bottom side 1002 of the carrier substrate 1 and electrically connected to the carrier substrate 1,” “the first filter assembly 3A including a first support element 31A disposed on the carrier substrate 1 and a first filter element 32A cooperating with the first support element 31A,” and “the first support element 31A being configured to carry the first filter element 32A so as to accommodate all or a part of the first filter element 32A in the first through opening 1003,” the image-capturing quality of the image-capturing device S can be improved. More particularly, when at least one first microparticle P1 with a maximum particle size between 5 μm and 25 μm is located on the first filter element 32A, a shortest distance D between the first filter element 32A and the first image sensing chip 2A is between 30 μm and 200 μm, so that the first image sensing chip 2A cannot capture a light spot generated due to blocking of the at least one first microparticle P1.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An image-capturing device, comprising:
a carrier substrate having a top side, a bottom side, a first through opening and a second through opening, wherein the first through opening and the second through opening are connected between the top side and the bottom side;
a first image sensing chip disposed on the bottom side of the carrier substrate and electrically connected to the carrier substrate;
a second image sensing chip disposed on the bottom side of the carrier substrate and electrically connected to the carrier substrate;
a first filter assembly corresponding to the first image sensing chip, wherein the first filter assembly includes a first support element disposed on the carrier substrate and a first filter element cooperating with the first support element;
a second filter assembly corresponding to the second image sensing chip, wherein the second filter assembly includes a second support element disposed on the carrier substrate and a second filter element cooperating with the second support element;
a first lens assembly corresponding to the first image sensing chip, wherein the first lens assembly includes a first lens holder disposed on the top side of the carrier substrate and a first optical lens carried by the first lens holder; and
a second lens assembly corresponding to the second image sensing chip, wherein the second lens assembly includes a second lens holder disposed on the top side of the carrier substrate and a second optical lens carried by the second lens holder;
wherein the first image sensing chip, the first filter assembly and the first lens assembly cooperate with each other to form a first image sensing module for capturing invisible light;
wherein the second image sensing chip, the second filter assembly and the second lens assembly cooperate with each other to form a second image sensing module for capturing visible light;
wherein the first support element is configured to carry the first filter element, so that all or a part of the first filter element is accommodated in the first through opening;
wherein the second support element is configured to carry the second filter element, so that all or a part of the second filter element is accommodated in the second through opening;
wherein, when at least one first microparticle with a maximum particle size between 5 μm and 25 μm is located on the first filter element, a shortest distance between the first filter element and the first image sensing chip is between 30 μm and 200 μm, so that the first image sensing chip cannot capture a light spot generated due to blocking of the at least one first microparticle;
wherein, when at least one second microparticle with a maximum particle size between 5 μm and 25 μm is located on the second filter element, a shortest distance between the second filter element and the second image sensing chip is between 30 μm and 200 μm, so that the second image sensing chip cannot capture a light spot generated due to blocking of the at least one second microparticle.

2. The image-capturing device according to claim 1, further comprising:
an electrical connector disposed on the top side of the carrier substrate and electrically connected to the carrier substrate;
an ambient light sensor disposed on the top side of the carrier substrate and electrically connected to the carrier substrate;
an infrared generator disposed on the top side of the carrier substrate and electrically connected to the carrier substrate;
an image processor disposed on the top side of the carrier substrate and electrically connected to the carrier substrate; and
a sound receiver disposed on the top side of the carrier substrate and electrically connected to the carrier substrate;
wherein the electrical connector, the first image sensing module, the ambient light sensor, the infrared generator, the second image sensing module, the image processor and the sound receiver are sequentially disposed on the carrier substrate, and the ambient light sensor and the infrared generator are closer to the first image sensing module than the second image sensing module;
wherein the first image sensing chip is electrically connected to the carrier substrate through a plurality of first conductive materials, and the second image sensing chip is electrically connected to the carrier substrate through a plurality of second conductive materials;
wherein the first image sensing chip is an infrared photosensitive chip, the first filter element is an infrared filter, and the first optical lens is an infrared lens;
wherein the second image sensing chip is a visible light photosensitive chip, the second filter element is a visible light filter, and the second optical lens is a visible light lens;
wherein a minimum thickness of the first support element is smaller than a thickness of the first filter element, the minimum thickness of the first support element is between 0.05 mm and 0.08 mm, and the thickness of the first filter element is between 1 mm and 1.5 mm;
wherein a minimum thickness of the second support element is smaller than a thickness of the second filter element, the minimum thickness of the second support element is between 0.05 mm and 0.08 mm, and the thickness of the second filter element is between 1 mm and 1.5 mm;
wherein an overall thickness of the second image sensing module is greater than an overall thickness of the first image sensing module, and the overall thickness of the first image sensing module and the overall thickness of the second image sensing module are not greater than 1.8 mm;
wherein the first support element is only connected to the carrier substrate and is not in contact with the first image sensing chip, and the second support element is only connected to the carrier substrate and is not in contact with the second image sensing chip;
wherein the first support element is connected between the carrier substrate and the first filter element through a plurality of first adhesive layers, and the second support element is connected between the carrier substrate and the second filter element through a plurality of second adhesive layers;
wherein the first lens holder downwardly contacts the first support element or is separate from the first support element, and the second lens holder downwardly contacts the second support element or is separate from the second support element.

3. The image-capturing device according to claim 1,
wherein the top side of the carrier substrate has a first left top carrier surface and a first right top carrier surface, the first left top carrier surface has a first inner surface and a first outer surface that are flush with each other or have a height difference, and the first right top carrier surface has a first inner surface and a first outer surface that are flush with each other or have a height difference;
wherein the first inner surface of the first left top carrier surface and the first inner surface of the first right top carrier surface are configured to carry the first support element, and the first outer surface of the first left top carrier surface and the first outer surface of the first right top carrier surface are configured to carry the first lens holder;
wherein, when the first inner surface and the first outer surface of the first left top carrier surface have a height difference, and the first inner surface and the first outer surface of the first right top carrier surface have a height difference, the carrier substrate provides a first left recessed space and a first right recessed space for respectively accommodating a first left outer portion and a first right outer portion of the first support element, thereby reducing the shortest distance between the first filter element and the first image sensing chip;
wherein the first filter element has a first left portion and a first right portion corresponding to the first left portion, at least one of an upper surface and a lower surface of the first left portion of the first filter element and all or a part of a lateral surface of the first left portion of the first filter element are covered by a first left inner portion of the first support element, and at least one of an upper surface and a lower surface of the first right portion of the first filter element and all or a part of a lateral surface of the first right portion of the first filter element are covered by a first right inner portion of the first support element;
wherein the top side of the carrier substrate has a second left top carrier surface and a second right top carrier surface, the second left top carrier surface has a second inner surface and a second outer surface that are flush with each other or have a height difference, and the second right top carrier surface has a second inner surface and a second outer surface that are flush with each other or have a height difference;
wherein the second inner surface of the second left top carrier surface and the second inner surface of the second right top carrier surface are configured to carry the second support element, and the second outer surface of the second left top carrier surface and the second outer surface of the second right top carrier surface are configured to carry the second lens holder;
wherein, when the second inner surface and the second outer surface of the second left top carrier surface have a height difference, and the second inner surface and the second outer surface of the second right top carrier surface have a height difference, the carrier substrate provides a second left recessed space and a second right recessed space for respectively accommodating a second left outer portion and a second right outer portion of the second support element, thereby reducing the shortest distance between the second filter element and the second image sensing chip;
wherein the second filter element has a second left portion and a second right portion corresponding to the second left portion, at least one of an upper surface and a lower surface of the second left portion of the second filter element and all or a part of a lateral surface of the second left portion of the second filter element are covered by a second left inner portion of the second support element, and at least one of an upper surface and a lower surface of the second right portion of the second filter element and all or a part of a lateral surface of the second right portion of the second filter element are covered by a second right inner portion of the second support element.

4. The image-capturing device according to claim 1,
wherein the bottom side of the carrier substrate has a first left bottom carrier surface and a first right bottom carrier surface, the first left bottom carrier surface has a first inner surface and a first outer surface that both have a height difference, and the first right bottom carrier surface has a first inner surface and a first outer surface that both have a height difference;
wherein the first inner surface of the first left bottom carrier surface and the first inner surface of the first right bottom carrier surface are configured to carry the first support element, and the first outer surface of the first left bottom carrier surface and the first outer surface of the first right bottom carrier surface are configured to carry the first image sensing chip;
wherein, the carrier substrate provides a first left recessed space and a first right recessed space for respectively accommodating a first left outer portion and a first right outer portion of the first support element, thereby reducing the shortest distance between the first filter element and the first image sensing chip;
wherein the bottom side of the carrier substrate has a second left bottom carrier surface and a second right bottom carrier surface, the second left bottom carrier surface has a second inner surface and a second outer surface that both have a height difference, and the second right bottom carrier surface has a second inner surface and a second outer surface that both have a height difference;
wherein the second inner surface of the second left bottom carrier surface and the second inner surface of the second right bottom carrier surface are configured to carry the second support element, and the second outer surface of the second left bottom carrier surface and the second outer surface of the second right bottom carrier surface are configured to carry the second image sensing chip;
wherein, the carrier substrate provides a second left recessed space and a second right recessed space for respectively accommodating a second left outer portion and a second right outer portion of the second support element, thereby reducing the shortest distance between the second filter element and the second image sensing chip.

5. A method of assembling an image-capturing device, comprising:
placing at least one test microparticle with a maximum particle size between 5 μm and 25 μm on a test filter element;
adjusting a shortest distance from the test filter element to a test image sensor chip until the test image sensor chip cannot capture a light spot generated due to blocking of the at least one test microparticle, in order to obtain a reference data of the shortest distance between the test filter element and the test image sensor chip ranging from 30 μm to 200 μm; and
according to the reference data, placing a first image sensing chip, a second image sensing chip, a first filter assembly, a second filter assembly, a first lens assembly and a second lens assembly on a carrier substrate, so that a shortest distance between the first filter element and the first image sensing chip is between 30 μm and 200 μm, and a shortest distance between the second filter element and the second image sensing chip is between 30 μm and 200 μm;
wherein the carrier substrate has a top side, a bottom side, a first through opening and a second through opening, and the first through opening and the second through opening are connected between the top side and the bottom side;
wherein the first image sensing chip and the second image sensing chip are disposed on the bottom side of the carrier substrate and electrically connected to the carrier substrate;
wherein the first filter assembly corresponds to the first image sensing chip, and the first filter assembly includes a first support element disposed on the carrier substrate and a first filter element cooperating with the first support element;
wherein the second filter assembly corresponds to the second image sensing chip, and the second filter assembly includes a second support element disposed on the carrier substrate and a second filter element cooperating with the second support element;
wherein the first lens assembly corresponds to the first image sensing chip, and the first lens assembly includes a first lens holder disposed on the top side of the carrier substrate and a first optical lens carried by the first lens holder;
wherein the second lens assembly corresponds to the second image sensing chip, and the second lens assembly includes a second lens holder disposed on the top side of the carrier substrate and a second optical lens carried by the second lens holder;
wherein the first image sensing chip, the first filter assembly and the first lens assembly cooperate with each other to form a first image sensing module for capturing invisible light;
wherein the second image sensing chip, the second filter assembly and the second lens assembly cooperate with each other to form a second image sensing module for capturing visible light;
wherein the first support element is configured to carry the first filter element, so that all or a part of the first filter element is accommodated in the first through opening;
wherein the second support element is configured to carry the second filter element, so that all or a part of the second filter element is accommodated in the second through opening.

6. The method of assembling the image-capturing device according to claim 5, further comprising:
placing an electrical connector, an ambient light sensor, an infrared generator, an image processor and a sound receiver on the top side of the carrier substrate to electrically connect to the carrier substrate;
wherein the electrical connector, the first image sensing module, the ambient light sensor, the infrared generator, the second image sensing module, the image processor and the sound receiver are sequentially disposed on the carrier substrate, and the ambient light sensor and the infrared generator are closer to the first image sensing module than the second image sensing module;
wherein the first image sensing chip is electrically connected to the carrier substrate through a plurality of first conductive materials, and the second image sensing chip is electrically connected to the carrier substrate through a plurality of second conductive materials;
wherein the first image sensing chip is an infrared photosensitive chip, the first filter element is an infrared filter, and the first optical lens is an infrared lens;
wherein the second image sensing chip is a visible light photosensitive chip, the second filter element is a visible light filter, and the second optical lens is a visible light lens;
wherein a minimum thickness of the first support element is smaller than a thickness of the first filter element, the minimum thickness of the first support element is between 0.05 mm and 0.08 mm, and the thickness of the first filter element is between 1 mm and 1.5 mm;
wherein a minimum thickness of the second support element is smaller than a thickness of the second filter element, the minimum thickness of the second support element is between 0.05 mm and 0.08 mm, and the thickness of the second filter element is between 1 mm and 1.5 mm;
wherein an overall thickness of the second image sensing module is greater than an overall thickness of the first image sensing module, and the overall thickness of the first image sensing module and the overall thickness of the second image sensing module are not greater than 1.8 mm;
wherein the first support element is only connected to the carrier substrate and is not in contact with the first image sensing chip, and the second support element is only connected to the carrier substrate and is not in contact with the second image sensing chip;
wherein the first support element is connected between the carrier substrate and the first filter element through a plurality of first adhesive layers, and the second support element is connected between the carrier substrate and the second filter element through a plurality of second adhesive layers;
wherein the first lens holder downwardly contacts the first support element or is separate from the first support element, and the second lens holder downwardly contacts the second support element or is separate from the second support element.

7. The method of assembling the image-capturing device according to claim 5,
wherein the top side of the carrier substrate has a first left top carrier surface and a first right top carrier surface, the first left top carrier surface has a first inner surface and a first outer surface that are flush with each other or have a height difference, and the first right top carrier surface has a first inner surface and a first outer surface that are flush with each other or have a height difference;
wherein the first inner surface of the first left top carrier surface and the first inner surface of the first right top carrier surface are configured to carry the first support element, and the first outer surface of the first left top carrier surface and the first outer surface of the first right top carrier surface are configured to carry the first lens holder;
wherein, when the first inner surface and the first outer surface of the first left top carrier surface have a height difference, and the first inner surface and the first outer surface of the first right top carrier surface have a height difference, the carrier substrate provides a first left recessed space and a first right recessed space for respectively accommodating a first left outer portion and a first right outer portion of the first support element, thereby reducing the shortest distance between the first filter element and the first image sensing chip;
wherein the first filter element has a first left portion and a first right portion corresponding to the first left portion, at least one of an upper surface and a lower surface of the first left portion of the first filter element and all or a part of a lateral surface of the first left portion of the first filter element are covered by a first left inner portion of the first support element, and at least one of an upper surface and a lower surface of the first right portion of the first filter element and all or a part of a lateral surface of the first right portion of the first filter element are covered by a first right inner portion of the first support element;
wherein the top side of the carrier substrate has a second left top carrier surface and a second right top carrier surface, the second left top carrier surface has a second inner surface and a second outer surface that are flush with each other or have a height difference, and the second right top carrier surface has a second inner surface and a second outer surface that are flush with each other or have a height difference;
wherein the second inner surface of the second left top carrier surface and the second inner surface of the second right top carrier surface are configured to carry the second support element, and the second outer surface of the second left top carrier surface and the second outer surface of the second right top carrier surface are configured to carry the second lens holder;
wherein, when the second inner surface and the second outer surface of the second left top carrier surface have a height difference, and the second inner surface and the second outer surface of the second right top carrier surface have a height difference, the carrier substrate provides a second left recessed space and a second right recessed space for respectively accommodating a second left outer portion and a second right outer portion of the second support element, thereby reducing the shortest distance between the second filter element and the second image sensing chip;
wherein the second filter element has a second left portion and a second right portion corresponding to the second left portion, at least one of an upper surface and a lower surface of the second left portion of the second filter element and all or a part of a lateral surface of the second left portion of the second filter element are covered by a second left inner portion of the second support element, and at least one of an upper surface and a lower surface of the second right portion of the second filter element and all or a part of a lateral surface of the second right portion of the second filter element are covered by a second right inner portion of the second support element.

8. The method of assembling the image-capturing device according to claim 5,
wherein the bottom side of the carrier substrate has a first left bottom carrier surface and a first right bottom carrier surface, the first left bottom carrier surface has a first inner surface and a first outer surface that both have a height difference, and the first right bottom carrier surface has a first inner surface and a first outer surface that both have a height difference;
wherein the first inner surface of the first left bottom carrier surface and the first inner surface of the first right bottom carrier surface are configured to carry the first support element, and the first outer surface of the first left bottom carrier surface and the first outer surface of the first right bottom carrier surface are configured to carry the first image sensing chip;
wherein, the carrier substrate provides a first left recessed space and a first right recessed space for respectively accommodating a first left outer portion and a first right outer portion of the first support element, thereby reducing the shortest distance between the first filter element and the first image sensing chip;
wherein the bottom side of the carrier substrate has a second left bottom carrier surface and a second right bottom carrier surface, the second left bottom carrier surface has a second inner surface and a second outer surface that both have a height difference, and the second right bottom carrier surface has a second inner surface and a second outer surface that both have a height difference;
wherein the second inner surface of the second left bottom carrier surface and the second inner surface of the second right bottom carrier surface are configured to carry the second support element, and the second outer surface of the second left bottom carrier surface and the second outer surface of the second right bottom carrier surface are configured to carry the second image sensing chip;
wherein, the carrier substrate provides a second left recessed space and a second right recessed space for respectively accommodating a second left outer portion and a second right outer portion of the second support element, thereby reducing the shortest distance between the second filter element and the second image sensing chip.

9. A portable electronic device using an image-capturing device, the image-capturing device comprising:
a carrier substrate having a top side, a bottom side, a first through opening and a second through opening, wherein the first through opening and the second through opening are connected between the top side and the bottom side;
a first image sensing chip disposed on the bottom side of the carrier substrate and electrically connected to the carrier substrate;
a first filter assembly corresponding to the first image sensing chip, wherein the first filter assembly includes a first support element disposed on the carrier substrate and a first filter element cooperating with the first support element; and
a first lens assembly corresponding to the first image sensing chip, wherein the first lens assembly includes a first lens holder disposed on the top side of the carrier substrate and a first optical lens carried by the first lens holder;
wherein the first image sensing chip, the first filter assembly and the first lens assembly cooperate with each other to form a first image sensing module for capturing invisible light;
wherein the first support element is configured to carry the first filter element, so that all or a part of the first filter element is accommodated in the first through opening;
wherein, when at least one first microparticle with a maximum particle size between 5 μm and 25 μm is located on the first filter element, a shortest distance between the first filter element and the first image sensing chip is between 30 μm and 200 μm, so that the first image sensing chip cannot capture a light spot generated due to blocking of the at least one first microparticle.

10. The portable electronic device according to claim 9,
wherein the top side of the carrier substrate has a first left top carrier surface and a first right top carrier surface, the first left top carrier surface has a first inner surface and a first outer surface that are flush with each other or have a height difference, and the first right top carrier surface has a first inner surface and a first outer surface that are flush with each other or have a height difference;
wherein the first inner surface of the first left top carrier surface and the first inner surface of the first right top carrier surface are configured to carry the first support element, and the first outer surface of the first left top carrier surface and the first outer surface of the first right top carrier surface are configured to carry the first lens holder;
wherein, when the first inner surface and the first outer surface of the first left top carrier surface have a height difference, and the first inner surface and the first outer surface of the first right top carrier surface have a height difference, the carrier substrate provides a first left recessed space and a first right recessed space for respectively accommodating a first left outer portion and a first right outer portion of the first support element, thereby reducing the shortest distance between the first filter element and the first image sensing chip;
wherein the first filter element has a first left portion and a first right portion corresponding to the first left portion, at least one of an upper surface and a lower surface of the first left portion of the first filter element and all or a part of a lateral surface of the first left portion of the first filter element are covered by a first left inner portion of the first support element, and at least one of an upper surface and a lower surface of the first right portion of the first filter element and all or a part of a lateral surface of the first right portion of the first filter element are covered by a first right inner portion of the first support element.
